(19) United States
(12) Patent Application Publication
(10) Pub. No.: US 2023/0089764 A1
(43) Pub. Date: Mar. 23, 2023

(54) CLEANING TOOL WITH INTEGRATED CONTAINER

(71) Applicant: Min HONG, Gwangju-si (KR)

(72) Inventor: Min HONG, Gwangju-si (KR)

(21) Appl. No.: 18/058,612

(22) Filed: Nov. 23, 2022

Related U.S. Application Data
(63) Continuation of application No. PCT/KR2021/007722, filed on Jun. 21, 2021.

(30) Foreign Application Priority Data
Jul. 30, 2020 (KR) 10-2020-0095229

(51) Int. Cl. B08B 1/00; A47L 17/06; B32B 27/30; B32B 27/32; B32B 27/08; B32B 15/20; B32B 15/082; B32B 15/085

(52) U.S. Cl. CPC B08B 1/005; A47L 17/06; B32B 27/306; B32B 27/32; B32B 27/08; B32B 15/20; B32B 15/082; B32B 15/085; B32B 2439/02

(57) ABSTRACT

One aspect of the present disclosure provides a cleaning tool including: a scraper; a container formed to extend from the scraper; and an outlet disposed at one end of the container, wherein a surface of at least one of the scraper and the container includes concave and convex portions, a sidewall of the container is made of a moisture-impermeable material, and the moisture-impermeable material includes a core layer and a skin layer formed on at least one surface of the core layer.

### CROSS-REFERENCE TO RELATED APPLICATION

This application is a continuation of International Patent Application No. PCT/KR2021/007722, filed on Jun. 21, 2021, which claims priority to and the benefit of Korean Patent Application No. 10-2020-0095229, filed on Jul. 30, 2020, the disclosure of which is incorporated herein by reference in its entirety.

### TECHNICAL FIELD

The present disclosure relates to a cleaning tool, and more particularly, to a cleaning tool capable of effectively removing various contaminants generated on a surface of an object, such as scales, dirt, and mold.

### BACKGROUND ART

Generally, dishes such as bowls or cups and washbasins, toilet bowls, bathtubs, or tiles installed in bathrooms or toilets are manufactured using high-strength metal or ceramic materials in order to improve ease of maintenance and appearance quality derived from the texture of the material.

The dishes, washbasins, or the like have an advantage that, due to being coated with a thin glaze made of glassy material to prevent moisture absorption or surface contamination, they are not easily corroded or damaged by the use of various detergents or cleaning tools. However, due to the nature of the use environment that is always exposed to moisture, scales may be easily generated on surfaces of the dishes, washbasins, or the like as moisture dries.

Scales are generated as deposits, which form due to trace minerals contained in tap water chemically reacting with various contaminants or detergents, adhere to surfaces of dishes, washbasins, or the like and accumulate. Scales cannot be easily removed by general detergents and cleaning tools and thus are removed using a tool such as a scraper.

A scraper is a tool configured to have a blade made of a plastic or metal material mounted thereon so that a user applies pressure to the blade to scrape foreign matter, such as scales, using a sharp corner of the blade. As disclosed in Korean Unexamined Patent Application Publication No. 10-2016-0101244, such a scraper includes a scraper main body on which a blade is formed and a handle connected to the scraper main body.

Since components of scales are not easily decomposed with general detergents, there is difficulty in removing scales generated on surfaces of dishes, washbasins, or the like using existing scrapers. Also, when scales or the like are removed using a scraper made of a plastic or metal material, a ceramic glaze on a finishing layer is removed together, and fine grooves are formed in surfaces of dishes, washbasins, or the like. When grooves are formed in a finishing layer surface, there are problems that scales are easily generated on the grooves, and the appearance quality is significantly degraded.

In relation to the above, Korean Patent Registration No. 10-2049702 discloses a cleaning tool for removing scales from a ceramic surface of dishes, washbasins, or the like in which a scraper of the cleaning tool, which includes the scraper, a fixing portion to which the scraper is fixed, and a grip connected to the fixing portion to serve as a handle, is formed by polyethylene and an ethylene vinyl alcohol copolymer being stacked in multiple layers, and a plurality of concave and convex portions are formed on both side surfaces of a blade at an end of the scraper to improve a scale removing effect.

However, in a case in which such a cleaning tool is applied along with a detergent, there is a problem that a user's fatigue is increased because the cleaning tool should be used after applying a detergent held in a separate container to the cleaning tool and/or a site to be cleaned, and in some cases, such a process should be repeated multiple times. Also, depending on the object to be cleaned and the purpose of cleaning, when a detergent and a cleaning tool are not independently properly combined, a sanitary condition of a cleaned site may rather be exacerbated.

### DISCLOSURE

### Technical Problem

The present disclosure is directed to providing a cleaning tool that allows a substance held in a container, such as a detergent, a cosmetic material, or a cleaning agent, to be conveniently applied as necessary while using a single cleaning tool and allows the container to serve as a handle to effectively remove various contaminants generated on a surface of an object, such as scales, dirt, and mold.

### Technical Solution

One aspect of the present disclosure provides a cleaning tool including: a scraper; a container formed to extend from the scraper; and an outlet disposed at one end of the container, wherein a surface of at least one of the scraper and the container includes concave and convex portions, a sidewall of the container is made of a moisture-impermeable material, and the moisture-impermeable material includes a core layer and a skin layer formed on at least one surface of the core layer.

In one embodiment, the scraper and the container may be integrally formed.

In one embodiment, at least one of the scraper and the container may be integrally formed with the concave and convex portions.

In one embodiment, the scraper may seal the other end of the container through a laminated structure of the moisture-impermeable material formed by hot-pressing the sidewall.

In one embodiment, a thickness of the scraper may be in a range of 0.1 mm to 10 mm.

In one embodiment, the concave and convex portions may include two or more protrusions formed in a predetermined pattern, and the two or more protrusions may be spaced apart at a first interval or a first distance ranging from 0.1 mm to 10 mm.

In one embodiment, the concave and convex portions may include a first protrusion portion and a second protrusion portion, the first and second protrusion portions may be spaced apart at a second interval or a second distance ranging from 0.1 mm to 200 mm, and the second interval may be formed in a direction different from the first interval.

In one embodiment, the concave and convex portions may include two or more linear protrusions formed in different directions.

In one embodiment, a height of the concave and convex portions may be in a range of 0.1 mm to 10 mm.

In one embodiment, at least one of the sidewall of the container and the scraper may include an antibacterial agent, a perfuming agent, or a combination thereof.

### Advantageous Effects

A cleaning tool according to one aspect of the present disclosure includes a scraper, a container formed to extend from the scraper, and an outlet disposed at one end of the container, and a surface of the scraper includes concave and convex portions. In this way, a substance held in a container, such as a detergent, a cosmetic material, or a cleaning agent, can be applied as necessary while using a single cleaning tool, and by the substance-holding container serving as a handle, various contaminants generated on a surface of an object, such as scales, dirt, and mold, can be to effectively removed.

The advantageous effects of the present disclosure are not limited to the above-mentioned advantageous effect and should be understood as including all advantageous effects inferable from the detailed description of the present disclosure or the configuration of the disclosure stated in the claims.

### DESCRIPTION OF DRAWINGS

FIG. 1 is a view illustrating a cleaning tool according to an embodiment of the present disclosure.

FIG. 2 is a view illustrating a cross-section of a scraper according to an embodiment of the present disclosure.

FIG. 3 is a view illustrating a method of manufacturing the scraper according to an embodiment of the present disclosure.

FIGS. 4A to 4C are views illustrating a surface of the scraper according to an embodiment of the present disclosure that is viewed from A or B of FIG. 1.

FIGS. 5A to 5D are views illustrating a pattern (plan view) of concave and convex portions according to an embodiment of the present disclosure.

FIG. 6 is a view illustrating a pattern (plan view) of concave and convex portions according to another embodiment of the present disclosure.

FIGS. 7A to 7D are views illustrating a surface of a scraper according to another embodiment of the present disclosure that is viewed from A or B of FIG. 1.

FIGS. 8A to 8D are views illustrating a pattern (plan view) of concave and convex portions according to another embodiment of the present disclosure.

FIG. 9 is a view illustrating a cross-section of a sidewall of a container according to an embodiment of the present disclosure.

### MODES OF THE INVENTION

Hereinafter, the present disclosure will be described with reference to the accompanying drawings. However, the present disclosure may be implemented in various forms and thus is not limited to the embodiments described herein. Also, for clear description of the present disclosure, parts unrelated to the description are omitted from the drawings, and like parts are denoted by like reference numerals throughout the specification.

Throughout the specification, when a certain part is described as being “connected” to another part, this not only includes a case where the two parts are “directly connected,” but also includes a case where the two parts are “indirectly connected” while another element is disposed therebetween. Also, when a certain part is described as “including” a certain element, unless otherwise stated, it means that the certain part may further include another element instead of excluding other elements.

Hereinafter, embodiments of the present disclosure will be described in detail with reference to the accompanying drawings.

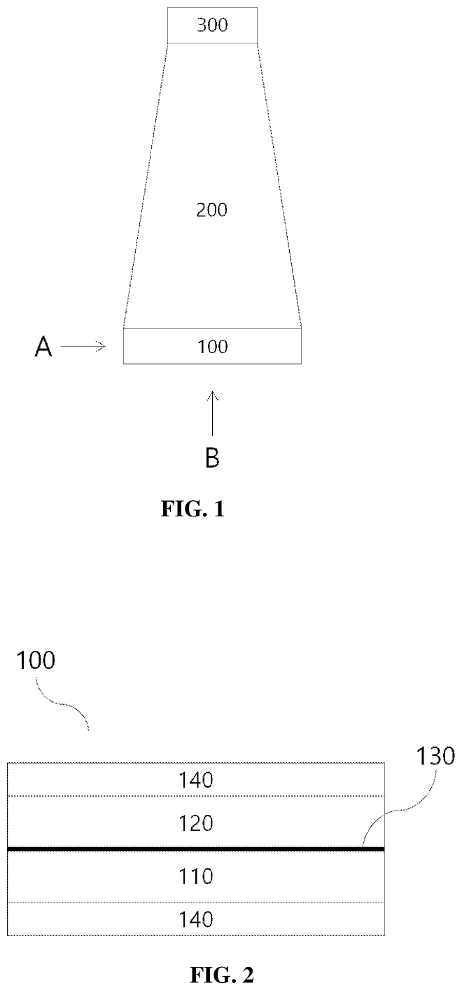

FIG. 1 is a view illustrating a cleaning tool according to an embodiment of the present disclosure, and FIG. 2 is a view illustrating a cross-section of a scraper according to an embodiment of the present disclosure.

Referring to FIGS. 1 and 2, a cleaning tool according to one aspect of the present disclosure includes a scraper 100, a container 200 formed to extend from the scraper 100, and an outlet 300 disposed at one end of the container 200, wherein a surface of at least one of the scraper 100 and the container 200 includes concave and convex portions 140, a sidewall of the container 200 is made of a moisture-impermeable material, and the moisture-impermeable material includes a core layer and a skin layer formed on at least one surface of the core layer.

The scraper 100 may come in contact with a site to be cleaned to remove contaminants generated on the site to be cleaned, and the concave and convex portions 140 included on the surface of the scraper 100 not only increase a contact surface with the site to be cleaned, but also substantially uniformly distribute a force, which is necessary to remove the contaminants from the site to be cleaned, throughout the contact surface to allow a user to more easily and effectively remove the contaminants.

The container 200 may be formed to extend from the scraper 100, and accordingly, the scraper 100 and the container 200 may be integrally formed. Specifically, the scraper 100 and the container 200 may be made of materials of the same type and/or quality and/or may be connected to each other by methods such as adhesion, sealing, and bending without any space therebetween. Also, the surface of the container 200 may include the concave and convex portions 140 formed in a predetermined pattern, and the concave and convex portions 140 included on the surface of the container 200 not only increase a contact surface with the site to be cleaned, but also substantially uniformly distribute a force, which is necessary to remove the contaminants from the site to be cleaned, throughout the contact surface to allow a user to more easily and effectively remove the contaminants.

In particular, in a case in which the surface of the scraper 100 and the surface of the container 200 both include the concave and convex portions 140, the entire area of the cleaning tool may substantially have a structure capable of removing contaminants generated on a site to be cleaned, and in a case in which the concave and convex portions 140 included in one area of the surfaces of the scraper 100 and the container 200 are worn out and a cleaning ability thereof is degraded, since cleaning can be performed using the concave and convex portions 140 included in other areas, the durability and lifespan of the cleaning tool can be increased.

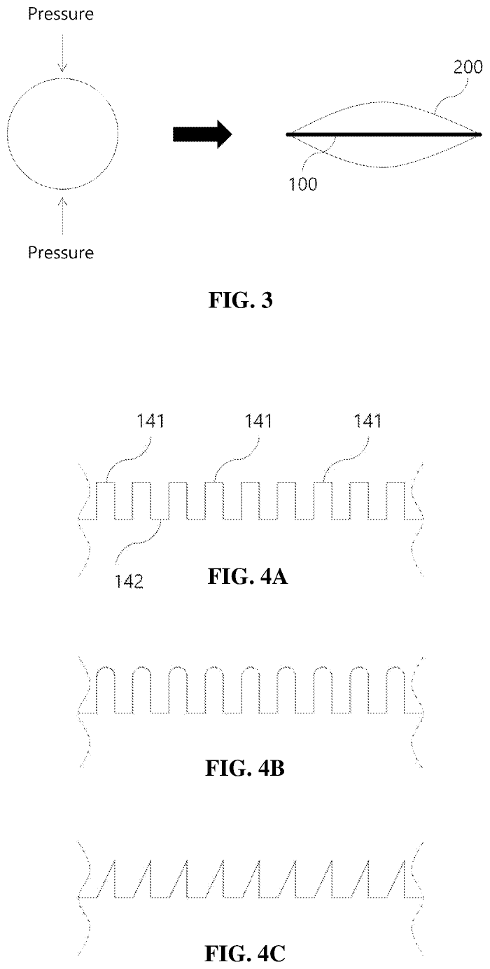

FIG. 3 is a view illustrating a method of manufacturing the scraper according to an embodiment of the present disclosure. Referring to FIG. 3, the scraper 100 may be formed by pressing the other end of the container 200, specifically, an outer surface of the other end of the sidewall of the container 200, using a roll, a stamp, or a member similar thereto having a pattern corresponding to the concave and convex portions included on the surface of the scraper 100, and when necessary, the member and/or the sidewall of the container may be heated during the pressing. The term, “the other end of the container” used herein refers to an end of the container 200 excluding a portion thereof to which the outlet 300 is coupled.

At least one of the scraper 100 and the container 200 may be integrally formed with the concave and convex portions 140. Specifically, at least one of the scraper 100 and the container 200 and the concave and convex portions 140 may be made of materials of the same type and/or quality and/or may be connected to each other by methods such as adhesion, sealing, and bending without any space therebetween.

Also, the concave and convex portions 140 may be formed by pressing the scraper 100 and/or the container 200 using a roll, a stamp, or a member similar thereto having a pattern corresponding to the concave and convex portions 140, and when necessary, the member and/or the scraper 100 and/or the container 200 may be heated during the pressing.

Also, the scraper 100, the container 200, and the concave and convex portions 140 may be integrally formed and may be implemented by a single process of pressing, preferably, hot-pressing the other end of the container 200, specifically, the other end of the sidewall of the container 200, using a roll, a stamp, or a member similar thereto having a pattern corresponding to the concave and convex portions to be formed on the surface of the scraper 100.

Surfaces of dishes, washbasins, or the like made of metal or ceramic materials are coated with a thin glaze made of glassy material to prevent moisture absorption or surface contamination and to improve the appearance quality. In a case in which a general scraper and blade made of plastic or metal materials are used to remove scales from dishes, washbasins, or the like made of ceramic materials, a glaze surface layer may be easily damaged due to a sharp corner of the blade, great force is required to use the cleaning tool due to friction occurring at a contact portion with the blade, and scales cannot be easily removed due to the blade not completely coming in close contact with surfaces of the dishes, washbasins, or the like. In relation thereto, the scraper 100 and the concave and convex portions 140 integrally formed therewith may come in close contact with a surface of an object to be cleaned and remove scales therefrom.

Also, the cleaning tool allows a substance held in the container, such as a detergent, a cosmetic material, or a cleaning agent, to be conveniently applied as necessary while using a single cleaning tool and allows the substance-holding container to serve as a handle to effectively remove various contaminants generated on a surface of an object, such as scales, dirt, and mold.

Referring to FIGS. 2 and 3, the sidewall of the container may be made of a moisture-impermeable material, and the scraper may seal the other end of the container through a laminated structure or a stacking structure of the moisture-impermeable material formed by hot-pressing the sidewall.

A container sidewall 200 may be made of a moisture-impermeable material, and the scraper 100 formed to seal the other end of the container as the other end of the container sidewall 200 is hot-pressed may also be made of a moisture-impermeable material. The term “moisture-impermeable” used herein refers to a property of substantially not allowing water and moisture to pass through, and the moisture-impermeable material may be nonporous and/or porous. In a case in which the moisture-impermeable material is porous, the minimum size of pores may be smaller than the minimum size of droplets of water and moisture generated during cleaning. Also, the moisture-impermeable material may be a soft material having flexibility, and the scraper 100 and the container 200 made of the moisture-impermeable material may also have a characteristic of being soft.

The sidewall of the container 200 may be made of a moisture-impermeable material, and the moisture-impermeable material may include a core layer and a skin layer formed on at least one surface of the core layer. The core layer and the skin layer may be made of materials including a polymer resin and/or a metal. The core layer and the skin layer may be made of materials of the same type or different types and may be face-on stacked in a thickness direction to constitute the moisture-impermeable material. Also, the core layer and/or the skin layer may each have a multilayer structure including one or more unit layers, and when necessary, an additional layer made of materials including a polymer resin and/or a metal may be formed on a surface of the skin layer.

For example, the container sidewall 200 may be made of a plastic barrier laminate (PBL) material including a core layer which includes ethylene vinyl alcohol and a skin layer which is formed on at least one surface of the core layer and includes polyethylene. Also, the container sidewall 200 may be made of an aluminum barrier laminate (ABL) material in which an aluminum film is interposed between the core layer and the skin layer or substituted with the core layer and/or the skin layer.

The PBL and/or ABL are soft materials and are highly corrosion-resistant and, when scales are removed using the cleaning tool, prevent minerals or various contaminants contained in the scales from easily being transferred or attached to the surface of the scraper 100. The PBL and/or ABL are mainly used for containers of toothpastes, cosmetic materials, or the like, and since a container discarded after a toothpaste or a cosmetic material is used up can be reused as it is or can be reused after undergoing proper posttreatment, not only is it eco-friendly, but also costs required for manufacturing the cleaning tool can be reduced.

The scraper 100 may seal the other end of the container 200 using a bilayer structure of the moisture-impermeable material in which the container sidewall 200 is hot-pressed, preferably, a bilayer structure in which a first moisture-impermeable layer 110 and a second moisture-impermeable layer 120 are combined via a bonding surface 130, and simultaneously secure mechanical properties such as strength and hardness at a level necessary to remove scales, dirt, mold, and the like.

The scraper 100 having a bilayer structure made of the PBL and/or ABL may reduce a frictional force with an object to be cleaned and, while having a hard surface, has a property of being prone to deformation in a direction in which force is applied. Therefore, without much force, a user may easily bring the cleaning tool in close contact with a curved surface of dishes, washbasins, or the like and easily remove scales generated on the surface. Also, the scraper 100 may prevent damage to a surface of an object to be cleaned and effectively prevent scales from generating again on a surface which is damaged after being cleaned.

A thickness of the scraper 100 may be in a range of 0.1 mm to 10 mm. For example, the thickness of the scraper 100 may be changed according to the number of core layers and/or skin layers constituting the PBL. In a case in which the thickness of the scraper 100 is less than 0.1 mm, not only is it not possible to secure mechanical properties such as strength and hardness at a level necessary to remove scales, dirt, mold, and the like, but also durability may be degraded. In a case in which the thickness of the scraper 100 is greater than 10 mm, flexibility, a feeling of use, compatibility with detergents, and a cleaning ability according thereto may be degraded.

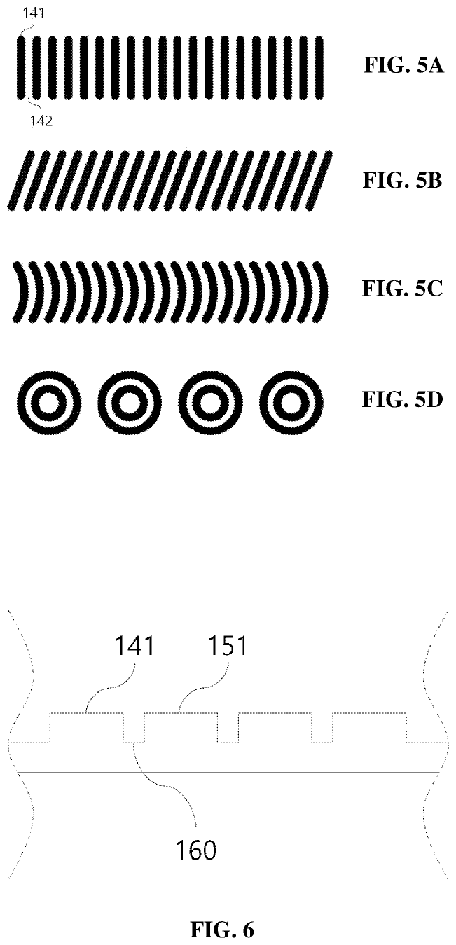

FIGS. 4A to 4C are views illustrating a surface of the scraper according to an embodiment of the present disclosure that is viewed from A or B of FIG. 1, and FIGS. 5A to 5D are views illustrating a pattern (plan view) of concave and convex portions according to an embodiment of the present disclosure.

Referring to FIGS. 4A to 5D, the concave and convex portions 140 may include two or more protrusions 141 formed in a predetermined pattern, and the two or more protrusions may be spaced apart at a first interval 142 ranging from 0.1 mm to 10 mm.

The first interval 142 refers to an interval between protrusions adjacent to each other among the two or more protrusions 141 included in the concave and convex portions 140 and/or an interval between protrusions adjacent to each other among two or more protrusions included in a second protrusion portion 151 which will be described below. In a case in which the first interval 142 is less than 0.1 mm, not only is it not possible to secure the minimum surface roughness necessary to remove scales and not possible to effectively remove scales due to an increase in resistance of water on a surface of an object to be cleaned, but also there is a problem that molding to assign intervals between protrusions is difficult. On the other hand, in a case in which the first interval 142 is greater than 10 mm, the number of protrusions per unit area and a surface area of each protrusion according thereto decrease, and thus scales cannot be effectively removed.

A cross-sectional area of a lower end of the protrusion may be greater than a cross-sectional area of an upper end of the protrusion. For example, the upper end of the protrusion may be treated to be round (FIG. 4B), molded into a needle-like form (FIG. 4C), or have a combination thereof but is not limited thereto. In a case in which a cross-sectional area of a lower end of the protrusion 141 is greater than a cross-sectional area of an upper end of the protrusion 141, while cleaning is performed, the lower end of the protrusion 141 may provide a support force and a fixing force, and simultaneously, an intermediate portion and the upper end of the protrusion 141 may provide flexibility and a cleaning ability according thereto to the protrusion 141.

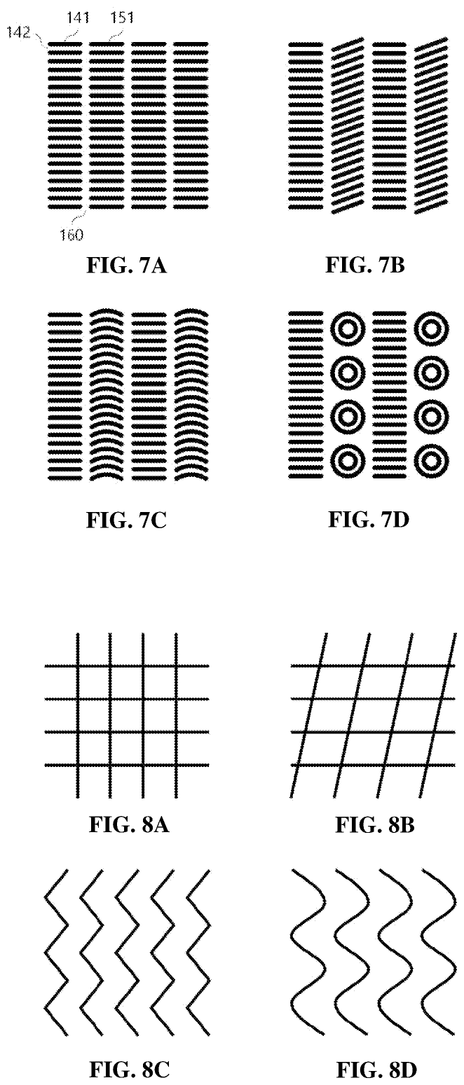

FIGS. 7A to 7D are views illustrating a surface of a scraper according to another embodiment of the present disclosure that is viewed from A or B of FIG. 1, and FIGS. 8A to 8D are views illustrating a pattern (plan view) of concave and convex portions according to another embodiment of the present disclosure.

Referring to FIGS. 7A to 7D, the concave and convex portions 140 may include a first protrusion portion 141 and the second protrusion portion 151, the first and second protrusion portions may be spaced apart at a second interval 160 ranging from 0.1 mm to 200 mm, and the second interval 160 may be formed in a direction different from the first interval 142, preferably, a vertical direction.

The first and second protrusion portions 141 and 151 may be spaced apart at the second interval 160 ranging from 0.1 mm to 200 mm. The second interval 160 may be defined as a thickness of a dividing line that partitions the first protrusion portion 141 and the second protrusion portion 151 adjacent thereto in a plan view of the concave and convex portions 140.

The size of the second interval 160 may be adjusted within the range of 0.1 mm to 200 mm according to the size of the scraper 100 according to an object to which the cleaning tool will be applied and may be, preferably, in a range of 0.1 mm to 100 mm and, more preferably, in a range of 0.1 mm to 50 mm. In a case in which the second interval 160 is less than 0.1 mm, not only is it not possible to secure the minimum surface roughness necessary to remove scales and not possible to effectively remove scales due to an increase in resistance of water on a surface of an object to be cleaned, but also there is a problem that molding to assign intervals between protrusions is difficult. On the other hand, in a case in which the second interval 160 is greater than 200 mm, the number of protrusions per unit area and a surface area of each protrusion according thereto decrease, and thus scales cannot be effectively removed.

Referring to FIGS. 8A to 8D, the first protrusion portion 141 and the second protrusion portion 151 may have the same patterns or may have different patterns as necessary. Also, protrusions included in the first protrusion portion 141 may be formed in the same pattern or may be formed in different patterns as necessary. Also, protrusions included in the second protrusion portion 151 may have the same pattern or may have different patterns as necessary.

The first and second protrusion portions 141 and 151 may be spaced apart at the second interval 160 and be formed to cross each other one or more times as necessary. FIGS. 8A to 8D show patterns formed by the first and second protrusion portions 141 and 151 crossing each other two times. In FIGS. 8A to 8D, a plurality of protrusions having a linear pattern may be arranged in parallel in the first protrusion portion 141, and the second protrusion portion 151 may have the same pattern as the first protrusion portion 141 (FIG. 8A), a plurality of protrusions having a linear pattern misaligned with the first protrusion portion 141 may be arranged in parallel in the second protrusion portion 151 (FIG. 8B), a plurality of protrusions having a curved pattern may be arranged in parallel in the second protrusion portion 151 (FIG. 8C), or the second protrusion portion 151 may consist of a plurality of protrusions having a concentric pattern (FIG. 8D).

Although not illustrated, a plurality of protrusions having a linear pattern may be arranged in parallel in the second protrusion portion 151, and the first protrusion portion 141 may have the same pattern as the second protrusion portion 151, a plurality of protrusions having a linear pattern misaligned with the second protrusion portion 151 may be arranged in parallel in the first protrusion portion 141, a plurality of protrusions having a curved pattern may be arranged in parallel in the first protrusion portion 141, or the first protrusion portion 141 may consist of a plurality of protrusions having a concentric pattern.

FIG. 6 is a view illustrating a pattern (plan view) of concave and convex portions according to another embodiment of the present disclosure. Referring to FIG. 6, the concave and convex portions may include two or more linear protrusions formed in different directions. The term “linear protrusion” used herein refers to a protrusion having a linear pattern made of straight lines, curved lines, or a combination thereof, and the linear pattern may be continuous or discontinuous.

Generally, since such concave and convex portions are formed only in one direction in a cleaning tool, there is a problem that the cleaning tool should be applied in a specific direction to remove scales, that is, a direction of applying the cleaning tool is limited due to the direction of the concave and convex portions and it is inconvenient to use. In relation thereto, since the concave and convex portions 140 include two or more linear protrusions formed in different directions, the cleaning tool can be conveniently used without a limitation in the direction of application, and scales can be effectively removed.

The linear protrusion may consist of two or more linear protrusions formed in different directions. The term “different directions” used herein may be interpreted as including: (1) a case in which two or more linear protrusions are not parallel to each other (FIGS. 6A and 6B); (2) a case in which one or more linear protrusions have a zigzag shape (FIG. 6C); and (3) a case in which tangent lines at two arbitrary points of one or more curved protrusions are not parallel to each other (FIG. 6D).

A height of the concave and convex portions 140, specifically, a height of the protrusions 141 and 151 included in the concave and convex portions 140, may be in a range of 0.1 mm to 10 mm. The height of the concave and convex portions 140 may be changed according to the number of core layers and/or skin layers constituting the PBL. In a case in which the height of the concave and convex portions 140 is less than 0.1 mm, scales cannot be effectively removed, and in a case in which the height of the concave and convex portions 140 is greater than 10 mm, a feeling of use may be degraded when a user uses the cleaning tool while directly holding the scraper 100 by hand.

Meanwhile, at least one of the sidewall of the container and the scraper may include an antibacterial agent, a perfuming agent, or a combination thereof.

The antibacterial agent and/or the perfuming agent may be properly distributed inside the sidewall of the container and/or the scraper or may be properly applied on surfaces of the sidewall of the container and/or the scraper.

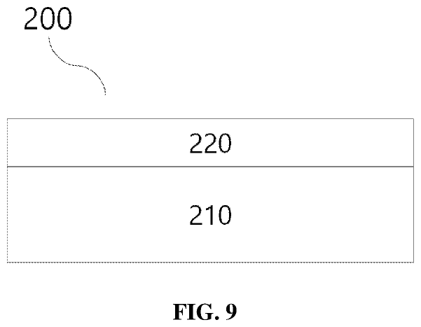

Also, the antibacterial agent and/or the perfuming agent may be mixed with a predetermined resin, e.g., polyethylene terephthalate (PET), and manufactured into the form of a film, and then the film may be attached to surfaces of the sidewall of the container and/or the scraper. FIG. 9 is a view illustrating a cross-section of the sidewall of the container according to an embodiment of the present disclosure. Referring to FIG. 9, the container sidewall 200 may include a moisture-impermeable layer 210 and a functional layer 220, and the film manufactured as above may be applied on the functional layer 220.

The antibacterial agent may be one selected from the group consisting of an inorganic antibacterial agent, an organic antibacterial agent, a metal-based antibacterial agent, an ammonium salt-based antibacterial agent, a guanidine-based antibacterial agent, a copper compound-based antibacterial agent, a sustained-release polymer antibacterial agent, a natural substance-based antibacterial agent, and combinations of two or more thereof but is not limited thereto.

The organic antibacterial agent is mostly in a liquid state. Due to having an advantage of displaying an immediate antibacterial effect by preventing formation of a bacterial colony rather than performing sterilization, the organic antibacterial agent may be added to products that require antibacterial power within short time. However, the organic antibacterial agent has disadvantages that the antibacterial power does not last, and the organic antibacterial agent is not applicable in high-temperature conditions due to having the possibility of being thermally decomposed. Also, the organic antibacterial agent may cause formation of resistant bacteria and may serve as a threat to human health due to having high acute toxicity. The organic antibacterial agent may be one selected from the group consisting of a thiabendazole-based antibacterial agent, an isothiazole-based antibacterial agent, a zinc pyrithione-based antibacterial agent, an imidazole-based antibacterial agent, a carbendazole-based antibacterial agent, a tricholomic acid-based antibacterial agent, and combinations of two or more thereof but is not limited thereto.

The natural substance-based antibacterial agent is a substance commonly encountered in everyday life, and although it is the safest for human health as well as being familiar to users, heat resistance and photostability thereof are low such that a range of application thereof is very limited, and since the antibacterial effect is low relative to the amount used, efficiency of the antibacterial agent may be degraded. The natural substance-based antibacterial agent may be one selected from the group consisting of moutan cortex, grapefruit seed, bamboo, fig, mugwort, aloe, red sage, phytoncide, green tea, and combinations of two or more thereof but is not limited thereto.

The inorganic antibacterial agent has low initial antibacterial power but, unlike the organic antibacterial agent, is highly safe for human health, has high thermal stability, does not cause formation of resistant bacteria, and has semipermanent antibacterial power. Therefore, the inorganic antibacterial agent has a wider range of application than the organic antibacterial agent. The inorganic antibacterial agent may be one selected from the group consisting of a zeolite-based antibacterial agent, a calcium phosphate-based antibacterial agent, a zirconium phosphate-based antibacterial agent, and combinations of two or more thereof and, preferably, may have metal ions with excellent antibacterial activity, such as silver (Ag), zinc (Zn), copper (Cu), and manganese (Mn), substituted in an inorganic carrier such as zeolite, calcium phosphate, and zirconium phosphate. Due to having a three-dimensional structure having fine pores, the inorganic antibacterial agent has a large specific surface area and excellent heat resistance. In particular, the zeolite-based antibacterial agent is the most widely used due to its high metal ion carrying amount. Also, the zeolite-based antibacterial agent does not have a discoloration problem unlike some other antibacterial agents and has advantages such as high antibacterial power, high safety, and low particle hardness. On the other hand, the calcium phosphate-based antibacterial agent has a disadvantage that antibacterial power is low due to a concentration of the substituted metal ions being lower as compared to the zeolite-based antibacterial agent.

The metal ions may be selected as necessary but, preferably, may be silver (Ag). Silver (Ag) has high antibacterial activity, is nontoxic and nonirritant for the human body, and has excellent durability and heat resistance. Also, since silver ions can be released over a long period of time, antibacterial power lasts long.

The perfuming agent may be a natural perfuming agent and may be, preferably, a plant oil. The plant oil is a volatile oil-phase substance that can be obtained from flowers, buds, fruits, leaves, branches, stems, and roots of plants or from natural resins, or the like and is lighter than water, may be referred to as an essential oil, and is differentiated from oil and fat. Generally, the plant oil may be made by a method in which water is added with a weight ratio of 1:1 to 1:100 to an extracted part of a plant and heated or a method in which a steam under pressure is passed so that an essential oil flows out together with the steam.

Examples of the method of making the plant oil include a steam distillation method in which an essential oil is caused to flow out at a temperature lower than the actual boiling point, a compression method in which fruit skin is compressed to make the plant oil, an adsorption method in which the plant oil is collected after being absorbed into a nonvolatile solvent such as fat, a solvent extraction method in which a volatile solvent is used to extract an aromatic component, a leaching method in which a cut is made in a stem or root of a plant and sap leaching out of the plant is collected, and a supercritical gas extraction method, but the examples are not limited thereto. The plant oil emits a specific scent according to different components and has excellent sterilizing power, disinfecting power, and antibacterial effect as compared to artificial synthetic components. The perfuming agent may be one selected from the group consisting of a pine-based performing agent, a jasmine-based perfuming agent, a lemon-based perfuming agent, a lavender-based perfuming agent, a mint-based perfuming agent, and combinations of two or more thereof but is not limited thereto.

Meanwhile, a substance held in the container 200, e.g., a detergent, a cosmetic material, a cleaning agent, or the like, may be, when necessary, applied to a site to be cleaned through the outlet 300 disposed at the one end of the container 200. The outlet 300 may be integrally formed with the container 200 and may, when necessary, further include a separate discharge means such as a cap including a spray and/or a pump and a truncated conical cap.

The above description of the present disclosure is only illustrative, and those of ordinary skill in the art to which the present disclosure pertains should understand that the present disclosure may be easily modified in other specific forms without changing the technical spirit or essential features of the present disclosure. Therefore, the embodiments described above should be understood as illustrative, instead of limiting, in all aspects. For example, each element described as a single type may also be embodied in a distributed manner, and likewise, elements described as being distributed may also be embodied in a combined form.

The scope of the present disclosure is shown by the claims below, and all changes or modifications derived from the meaning and scope of the claims and their equivalents should be interpreted as belonging to the scope of the present disclosure.

### DESCRIPTION OF REFERENCE NUMERALS

100: scraper

110: first moisture-impermeable layer

120: second moisture-impermeable layer

130: bonding surface

140: concave and convex portions

141: protrusion (first protrusion portion)

142: first interval

151: second protrusion portion

160: second interval

200: container or container sidewall

210: moisture-impermeable layer

220: functional layer

300: outlet

1. A cleaning tool comprising:
a scraper;
a container formed to extend from the scraper; and
an outlet disposed at one end of the container,
wherein a surface of at least one of the scraper and the container includes concave and convex portions,
a sidewall of the container is made of a moisture-impermeable material, and
the moisture-impermeable material includes a core layer and a skin layer formed on at least one surface of the core layer.

2. The cleaning tool according to claim 1, wherein the scraper and the container are integrally formed.

3. The cleaning tool according to claim 1, wherein at least one of the scraper and the container is integrally formed with the concave and convex portions.

4. The cleaning tool according to claim 1, wherein the scraper seals the other end of the container through a laminated structure of the moisture-impermeable material formed by hot-pressing the sidewall.

5. The cleaning tool according to claim 1, wherein a thickness of the scraper is in a range of 0.1 mm to 10 mm.

6. The cleaning tool according to claim 1, wherein:
the concave and convex portions include two or more protrusions formed in a predetermined pattern; and
the two or more protrusions are spaced apart at a first interval ranging from 0.1 mm to 10 mm.

7. The cleaning tool according to claim 6, wherein:
the concave and convex portions include a first protrusion portion and a second protrusion portion;
the first and second protrusion portions are spaced apart at a second interval ranging from 0.1 mm to 200 mm; and
the second interval is formed in a direction different from the first interval.

8. The cleaning tool according to claim 1, wherein the concave and convex portions include two or more linear protrusions formed in different directions.

9. The cleaning tool according to claim 1, wherein a height of the concave and convex portions is in a range of 0.1 mm to 10 mm.

10. The cleaning tool according to claim 1, wherein at least one of the sidewall of the container and the scraper includes an antibacterial agent, a perfuming agent, or a combination thereof.
